(19) United States
(12) Patent Application Publication
(10) Pub. No.: US 2007/0291419 A1
(43) Pub. Date: Dec. 20, 2007

(54) Apparatus and method for a vertical micro-acatuator in slider of a hard disk drive

(75) Inventors: SungChang Lee, San Jose, CA (US); Brian D. Strom, Cupertino, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/471,094

(22) Filed: Jun. 19, 2006

(51) Int. Cl. G11B 21/24

(52) U.S. Cl. 360/294.4

(57) ABSTRACT

Slider used to access data on rotating disk in hard disk drive, including vertical micro-actuator using shape memory alloy film perpendicular to air bearing surface and coupled to deformation region including read-write head. Slider further includes vertical control signal stimulating heating element coupled to film and/or second vertical control signal stimulating second heating element to alter vertical position. Flexure finger including micro-actuator assembly for coupling to slider, and possibly providing vertical control signal(s) to heating element(s). Head gimbal assembly including flexure finger coupled to the slider. A head stack assembly including at least one of the head gimbal assemblies coupled to a head stack. Hard disk drive including head stack assembly. The invention includes manufacturing the slider, the head gimbal assembly, the head stack assembly, and the hard disk drive, as well as these items as products of the invention's manufacturing processes.

### TECHNICAL FIELD

This invention relates to hard disk drives, in particular, to apparatus and methods for controlling the vertical position of the read-write head above a rotating disk surface in a hard disk drive.

### BACKGROUND OF THE INVENTION

Contemporary hard disk drives include an actuator assembly pivoting through an actuator pivot to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil and an actuator arm to move a head gimbal assembly in lateral positioning the slider close to the track. Once the read-write head is close to the track, the servo controller typically enters an operational mode known herein as track following. It is during track following mode that the read-write head is used to access the data stored of the track.

Micro-actuators provide a second actuation stage for lateral positioning the read-write head during track following mode. They often use an electrostatic effect and/or a piezoelectric effect to rapidly make fine position changes. They have doubled the bandwidth of servo controllers and are believed essential for high capacity hard disk drives from hereon.

A central feature of the hard disk drive industry is its quest for greater data storage density, leading to continued reduction in track width, the flying height or vertical positioning of the read-write head off the rotating disk surface, and the size of the read head within the read-write head. As these factor shrink, the possibility of the read-write head contacting the rotating disk surface increases and the potential for damage to the disk surface and the

There are a number of proposals and experimental devices pointing to mounting a vertical micro-actuator either directly coupled to the slider parallel the air bearing surface and often employing a piezoelectric effect to induce a strain on the slider to alter the vertical position of the read-write head above the rotating disk surface. These proposals have tended to be ineffective. Another alternative uses a heating element the vertical micro-actuator 98 embedded in a slider 90 to expand the slider distortion zone 97 and reduce the vertical distance Vp between the slider and a rotating disk surface 120-1 from an initial vertical distance Vp0 to a reduced vertical distance Vp1 as shown in FIG. 1A. While this approach is gaining favor at this time it has a significant limitation, it can only actively move the read-write head 94 closer to the rotating disk surface. There are situations where the read-write head needs to be further away from the rotating disk surface, and in those situations this approach does not help. What is needed is a vertical micro-actuator which can actively raise the read-write head.

### SUMMARY OF THE INVENTION

The invention includes a slider used to access data on a rotating disk in a hard disk drive. The slider includes a vertical micro-actuator including a film of shape memory alloy, referred to herein as a shape memory alloy film, perpendicular to the air bearing surface and coupled with a deformation region, which includes the read-write head. Whenever the temperature of the film is below a first temperature, the film configures in a first solid phase to the deformation region to create the vertical position of the read-write head above the rotating disk surface as shown on the left side of FIGS. 1B and 1C. Whenever the temperature of the film is above the first temperature, the film configures in a second solid phase to the deformation region increasing the vertical position of the read-write head above the rotating disk surface, as shown on the right side of FIGS. 1B and 1C. Hard disk drives typically experience a wide range of temperatures, and the deformation region expands when the hard disk drive experiences high temperatures, which lowers the vertical position and increases the probability of contact between the slider and the rotating disk surface and the subsequent degradation in the rotating disk surface and/or the slider.

The vertical micro-actuator may further include a heating element coupled with the shape memory alloy film, and stimulated by a vertical control signal providing a potential difference with a first slider power terminal, to alter a vertical position of the read-write head over the rotating disk surface in a hard disk drive as shown in FIGS. 1B and 8B. The vertical control signal stimulates the vertical micro-actuator to increase the vertical position by stimulating the heating element to increase the temperature of the shape memory alloy film, which when it is above the first temperature the film configures in the second solid phase to the deformation region, increasing the vertical position.

The vertical micro-actuator may further include a second heating element embedded in the deformation region, which may preferably and independently heat the deformation region when stimulated by a second vertical control signal providing a second potential difference with the first slider power terminal. An example of the vertical micro-actuator including both the heating element and the second heating element is shown in FIGS. 10A and 10B, and just including the second heating element is shown in FIG. 10C. Examples of the control signals for the vertical micro-actuator including both the heating elements is shown in FIG. 11A, and including just the second heating element is shown in FIG. 11B. These embodiments further operate by using the second vertical control signal to stimulate the second heating element to heat the deformation region, causing the vertical position to become smaller, which is denoted as Vpless in FIG. 10A.

The first temperature may be selected differently for sliders including the heating element coupled with the shape memory alloy film from sliders including just the shape memory alloy film. Alternatively, the first temperature may be selected as the same for both slider embodiments. In certain preferred embodiments, the first temperature may be between fifty five and sixty five degrees Centigrade. The temperature of the shape memory alloy film being above the first temperature may include the temperature being greater than the first temperature, or alternatively, the temperature may be greater than or equal to the first temperature. Similarly, the temperature being below the first temperature may include, the temperature less than or equal to the first temperature, or alternatively, the temperature less than the first temperature. The vertical micro-actuator, in particular, the heating element may preferably include Copper. The vertical micro-actuator, in particular, the heating element can be can be used to deform the deformation region when the temperature of the shape memory alloy film 98-F is below the first temperature. In certain embodiments, the shape memory alloy film 98-F may b coupled to a layer of piezoelectric material to form the vertical micro-actuator with the ability to compensate for thermal pole tip protrusion.

The slider, and its read-write head may further include a read head using a spin valve to read the data on the rotating disk surface, or use a tunneling valve to read the data. The slider may further include the read head providing a read differential signal pair to an amplifier to generate an amplified read signal reported by the slider as a result of the read access of the data on the rotating disk surface. The amplifier may be opposite the air bearing surface, and may be separate from the deformation region, and may further be separate from the vertical micro-actuator.

The flexure finger may include a micro-actuator assembly for mechanically coupling to an embodiment of the slider. The flexure finger may include a vertical control signal path providing the vertical control signal to the slider and the heating element in its vertical micro-actuator. The micro-actuator assembly may aid in lateral positioning, and may further aid in vertical positioning of the read-write head over the data of the rotating disk surface. The micro-actuator assembly may employ a piezoelectric effect and/or an electrostatic effect to aid in positioning the read-write head.

The invention also includes a head gimbal assembly including the invention's flexure finger coupled to the slider, which further includes the micro-actuator assembly mechanically coupled to the slider and may further include the vertical control signal path electrically coupled to the vertical control signal of the slider. The invention includes a head stack assembly including at least one of the head gimbal assemblies coupled to a head stack. The invention includes a hard disk drive including a head stack assembly, which includes at least one of the head gimbal assemblies.

The invention includes manufacturing the slider, the flexure finger, the head gimbal assembly, the head stack assembly, and the hard disk drive, as well as these items as products of the invention's manufacturing processes.

### BRIEF DESCRIPTION OF THE DRAWINGS

FIG. 1A shows an example prior art slider including a vertical micro-actuator employing a heater;

FIGS. 1B and 1C show an example of the invention's slider increasing the vertical distance and decreasing the vertical distance of its read-write head to the data on the rotating disk surface;

FIGS. 2A and 2B show some aspects of the invention's flexure finger and head gimbal assembly and their relationship with the invention's slider;

FIG. 3A shows an example of the read head of FIG. 2A employing a spin valve;

FIG. 3B shows an example of the read head of FIG. 2A employing a tunnel valve;

FIG. 3C shows a typical polarization of bits in the track on the rotating disk surface used with the spin valve of FIG. 3A, which is parallel the rotating disk surface;

FIG. 3D shows a typical polarization of bits in the track on the rotating disk surface used with the valve of FIG. 3B, which is perpendicular to the rotating disk surface;

FIG. 4A shows a partially assembled hard disk drive of FIG. 2A;

FIG. 4B shows the head gimbal assembly of FIGS. 2A and 2B including the slider of coupled with a micro-actuator assembly using the piezoelectric effect;

FIGS. 5 to 7 show some details of the hard disk drive of FIGS. 2A and 4A;

FIG. 8A shows an example of the use of the piezoelectric effect in the micro-actuator assembly of FIG. 4B;

FIG. 8B shows a refinement of the head gimbal assembly, the flexure finger, and the slider of FIG. 2A;

FIGS. 9A and 9B show an example of the use of the electrostatic effect in a micro-actuator assembly for the head gimbal assembly of FIG. 2A;

FIGS. 10A and 10B show an example of the vertical micro-actuator including the heating element and a second heating element;

FIG. 10C shows an example of the vertical micro-actuator including just the second heating element;

FIG. 11A shows an example of the vertical control signal for stimulating the heating element and a second vertical control signal for stimulating the second heating element of FIGS. 10A and 10B; and

FIG. 11B shows the second vertical control signal for stimulating the second heating element of FIG. 10C.

### DETAILED DESCRIPTION

This invention relates to hard disk drives, in particular, to apparatus and methods for controlling the vertical position of the read-write head above a rotating disk surface in a hard disk drive. In particular, to a slider comprising a vertical micro-actuator including a film of a shape memory alloy perpendicular to an air bearing surface acting to increase the vertical distance between the read-write head and the rotating disk surface whenever the temperature of the film is above a first temperature.

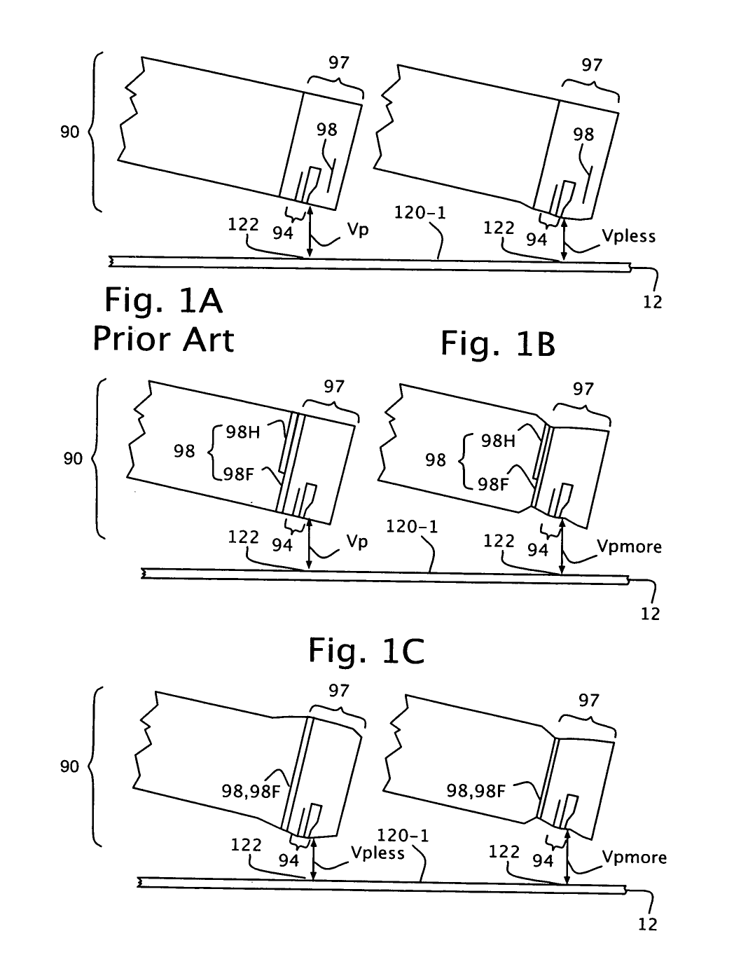

The slider 90 contains a vertical micro-actuator 98 including a film of shape memory alloy, referred to herein as a shape memory alloy film 98F, perpendicular to the air bearing surface 92 and coupled with a deformation region 97, which includes the read-write head 94, as shown in FIGS. 1B, 1C, 2A, 2B, 4B, 8B and 9A. Whenever the temperature of the film is below a first temperature, the film configures in a first solid phase to the deformation region to create the vertical position Vp of the read-write head above the rotating disk surface 120-1 as shown on the left side of FIGS. 1B and 1C. Whenever the temperature of the film is above the first temperature, the film configures in a second solid phase to the deformation region increasing the vertical position of the read-write head above the rotating disk surface, as shown on the right side of FIGS. 1B and 1C.

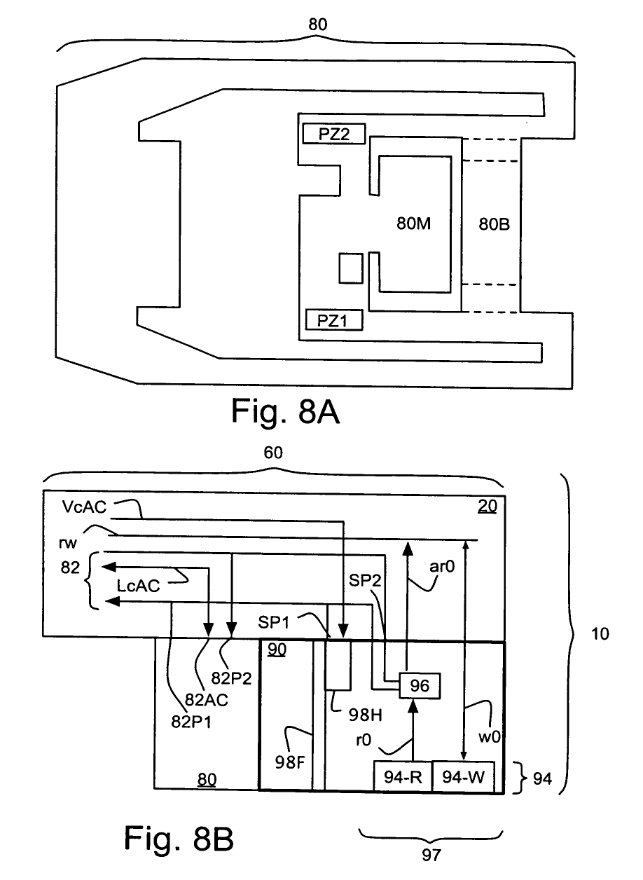

The vertical micro-actuator 98 may further include a heating element 98H coupled with the shape memory alloy film 98F, and stimulated by a vertical control signal VcAC providing a potential difference with a first slider power terminal SP1, to alter a vertical position VP of the read-write head over the rotating disk surface 120-1 in a hard disk drive 10 as shown in FIGS. 1B and 8B. The vertical control signal stimulates the vertical micro-actuator to increase the vertical position by stimulating the heating element to increase the temperature of the shape memory alloy film, which when it is above the first temperature the film configures in the second solid phase to the deformation region, increasing the vertical position. The heating element may preferably be made of a copper compound. In certain embodiments, the heating element may be used to alter the vertical position be increasing the temperature below the first temperature, reducing the vertical position of the read-write head 94.

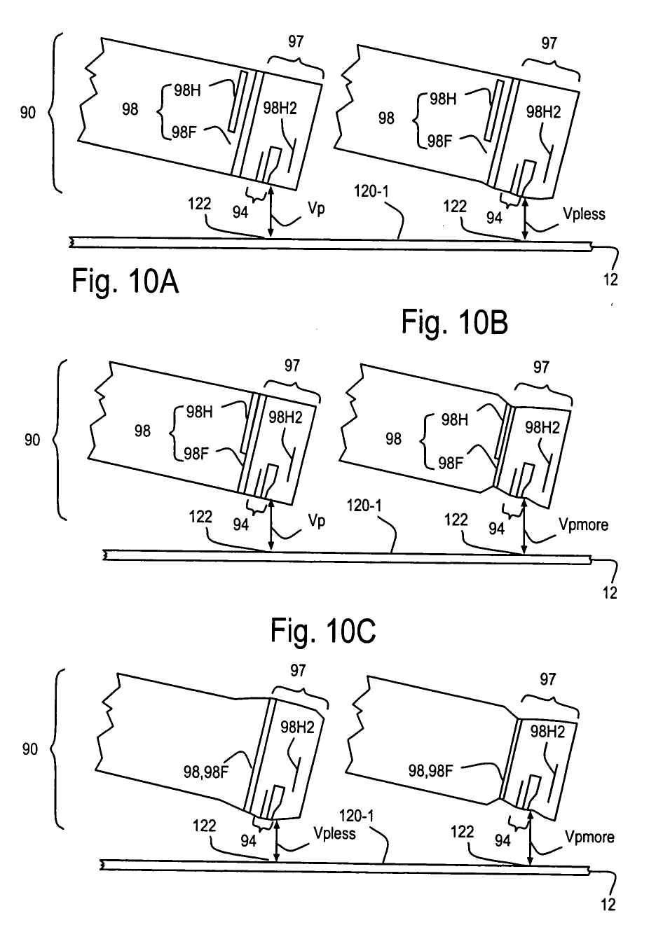

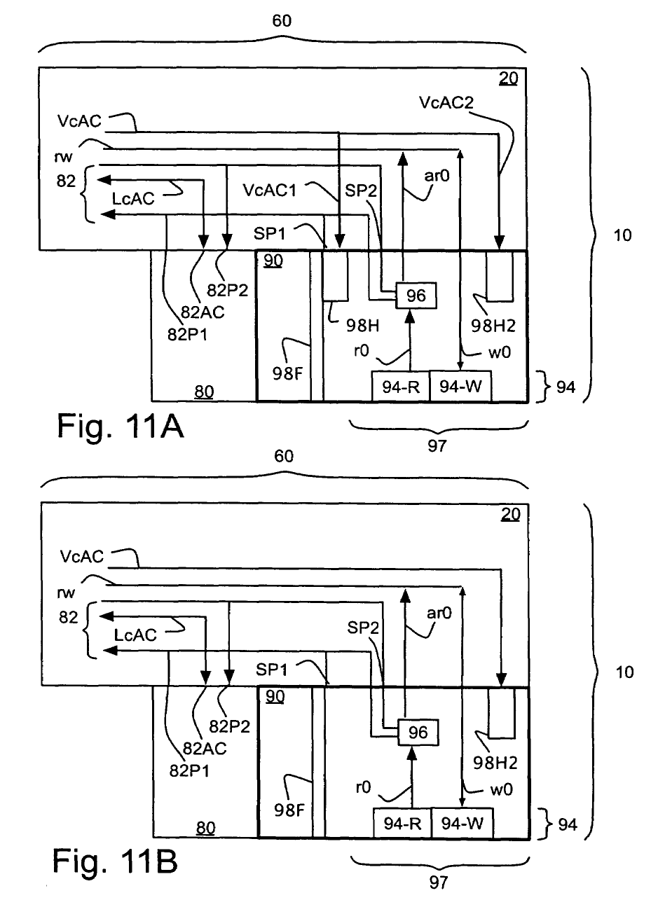

The vertical micro-actuator 98 may further include a second heating element 98H2 embedded in the deformation region 97, which may preferably and independently heat the deformation region when stimulated by a second vertical control signal VcAC2 providing a second potential difference with the first slider power terminal SP1. An example of the vertical micro-actuator including both the heating element and the second heating element is shown in FIGS. 10A and 10B, and just including the second heating element is shown in FIG. 10C. Examples of the control signals for the vertical micro-actuator including both the heating elements is shown in FIG. 1A, and including just the second heating element is shown in FIG. 11B. These embodiments further operate by using the second vertical control signal to stimulate the second heating element to heat the deformation region, causing the vertical position Vp to become smaller, which is denoted as Vpless in FIG. 10A.

The first temperature may be selected differently for the slider 90 including the heating element 98H coupled with the shape memory alloy film 98F from the slider including just the shape memory alloy film. Alternatively, the first temperature may be selected as the same for both slider embodiments. In certain preferred embodiments, the first temperature may be between fifty five and sixty five degrees Centigrade. The temperature of the shape memory alloy film being above the first temperature may include the temperature being greater than the first temperature, or alternatively, the temperature may be greater than or equal to the first temperature. Similarly, the temperature being below the first temperature may include, the temperature less than or equal to the first temperature, or alternatively, the temperature less than the first temperature.

The slider, and its read-write head may further include a read head using a spin valve to read the data on the rotating disk surface, or use a tunneling valve to read the data. The slider may further include the read head providing a read differential signal pair to an amplifier to generate an amplified read signal reported by the slider as a result of the read access of the data on the rotating disk surface. The amplifier may be opposite the air bearing surface, and may be separate from the deformation region, and may further be separate from the vertical micro-actuator.

The slider 90 is used to access the data 122 on the rotating disk surface 120-1 in a hard disk drive 10. The data is typically organized in units known as a track 122, which are usually arranged in concentric circles on the rotating disk surface centered about a spindle shaft 40 and alternatively may be organized as joined spiral tracks. Operating the slider to read access the data on the rotating disk surface includes the read head 94-R driving the read differential signal pair r0 to read access the data on the rotating disk surface. The read-write head 94 is formed perpendicular to the air bearing surface 92 to the amplifier 96.

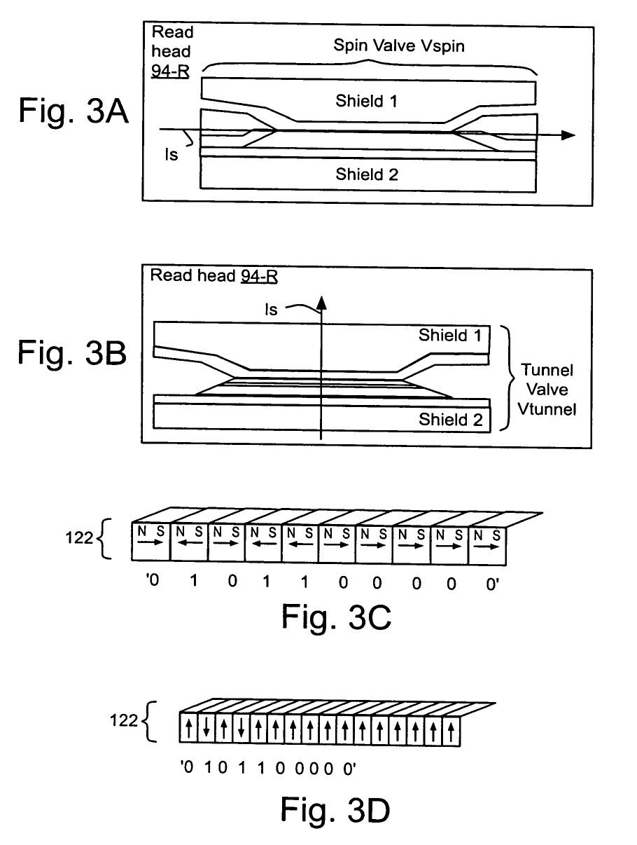

The read head 94-R may use a spin valve to drive the read differential signal pair as shown in FIG. 3A. As used herein, the spin valve employs a magneto-resistive effect to create an induced sensing current Is between the first shield Shield1 and the second shield Shield2. Spin valves have been in use the since the mid 1990's.

The read head 94-R may use a tunnel valve to drive the read differential signal pair as shown in FIG. 3B. As used herein, a tunnel valve uses a tunneling effect to modulate the sensing current Is perpendicular to the first shield Shield1 and the second shield Shield2. Both longitudinally recorded signals as shown in FIG. 3C and perpendicularly recorded signals shown in FIG. 3D can be read by either reader type. Perpendicular versus longitudinal recording relates to the technology of the writer/media pair, not just the reader. This difference in bit polarization lead to the announcement of a large increase in data density, a jump of almost two hundred percent in the spring of 2005.

The tunnel valve is used as follows. A pinned magnetic layer is separated from a free ferromagnetic layer by an insulator, and is coupled to a pinning antiferromagnetic layer. The magneto-resistance of the tunnel valve is caused by a change in the tunneling probability, which depends upon the relative magnetic orientation of the two ferromagnetic layers. The sensing current Is, is the result of this tunneling probability. The response of the free ferromagnetic layer to the magnetic field of the bit of the track 122 of the rotating disk surface 120-1, results in a change of electrical resistance through the tunnel valve.

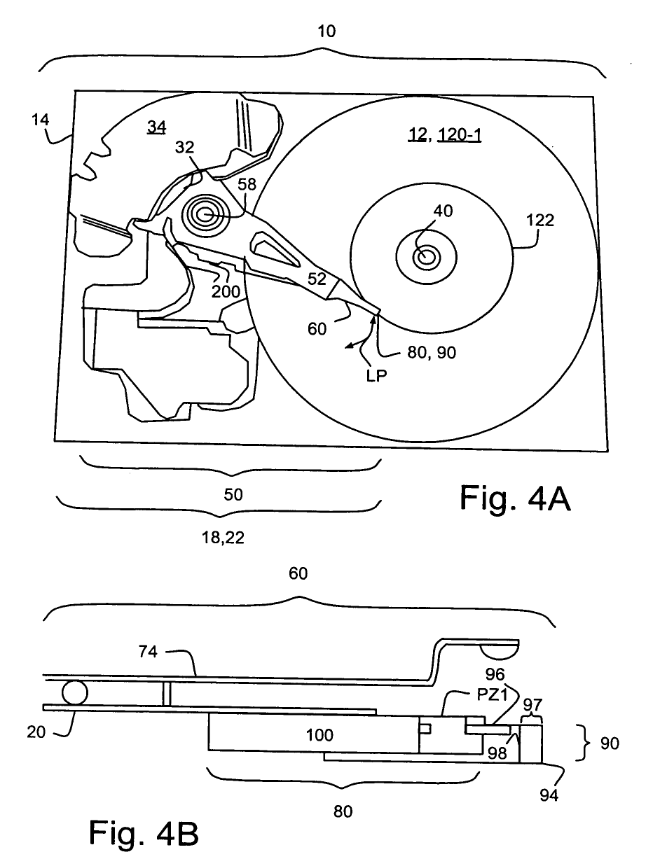

The invention's slider 90 may further include the read-write head 94 providing the read-differential signal pair r0 to the amplifier 96 to generate the amplified read signal ar0, as shown in FIG. 8B. The read-write head preferably includes a read head 94-R driving the read differential signal pair r0 and a write head 94-W receiving a write differential signal pair w0. The slider reports the amplified read signal as a result of read access of the data on the rotating disk surface. In most but not necessarily all of the embodiments of the invention's slider, the amplifier is preferably opposite the air bearing surface 92. The amplified read signal ar0 may be implemented as an amplified read signal pair ar0+− or as a single ended read signal. The vertical micro-actuator 98 included in the slider operates by inducing a strain on the deformation region 97 as well as any other materials directly coupled to it, making it preferable for the amplifier to be separated from the vertical micro-actuator and the deformation region, as shown in FIGS. 4B, 8B, and 9A. These embodiments of the invention's slider preferably include a first slider power terminal SP1 and a second slider power terminal SP2 collectively used to power the amplifier in generating the amplified read signal ar0.

Manufacturing the invention's slider 90 may include the following and/or similar steps: Forming the vertical micro-actuator 98 as the film of the shape memory alloy, also referred to herein as the shape memory alloy film 98F. The film may be formed by sputtering and/or electro-deposited, forming the shape memory alloy film. Contemporary manufacturing technologies are called out in “Fabrication of TiNi shape memory alloy microactuators by ion beam sputter deposition” by Tsuchiya and Davies, in Nanotechnology 9, pages 67 to 71, (1998), which is incorporated herein by reference. When deposited by sputtering, the initial stress state of the shape memory alloy film may be controlled by deposition at low temperatures, or by controlling the deposition process to impart a residual tensile stress in the film. Alternatively, the shape memory alloy film may be fabricated separately and then bonded to the substrate or slider structure, preferably having been put under tensile stress before being bonded. Forming the air bearing surface 92 may include a photo-etching or other lithographic process.

A shape memory alloy as used herein is a solid material having two solid phases, so that when subjected to changes in temperature or pressure, the material tends to go from the first solid phase to the second or from the second solid phase to the first. A shape memory alloy of two or more elements will refer to any molecular or crystalline combination of those elements which is a solid possessing the shape memory property of two solid phases in the operating and storage conditions of a hard disk drive.

The shape memory alloy may include at least one member of the titanium nickel shape memory alloy group consisting of: a Titanium Nickel (TiNi) alloy, a Titanium Nickel Iron (Ti—Ni—Fe) alloy, a Titanium Nickel Copper (Ti—Ni—Cu) alloy, a Titanium Nickel Lead (Ti—Ni—Pb) alloy, and a Titanium Nickel Hafnium (Ti—Ni—Hf) alloy.

Manufacturing the invention's slider 90 may further include the step of forming the heating element 98H coupled to the shape memory alloy film 98F. The forming of the heating element may involve sputtering and/or electro-deposition onto the shape memory alloy film. Alternatively, the heating element may be formed first, and the shape memory alloy film may be formed coupled to the heating element.

Manufacturing the slider 90 may further include coupling the read-write head 94 to the amplifier 96, which further includes electrically coupling the read differential signal pair to the amplifier. The invention includes the manufacturing process of the slider and the slider as a product of that manufacturing process. The manufacturing further includes providing an air bearing surface 92 near the read head 94-R.

Coupling the read-write head 94 to the amplifier 96 may further include bonding the amplifier to the read head 94-R and/or building the amplifier to the read head. Bonding the amplifier may include gluing, and/or welding, and/or soldering the amplifier to the read head. Building the amplifier may include depositing an insulator to create a signal conditioning base, and/or using a slider substrate as a signal conditioning base, and/or depositing a first semiconductor layer on the signal conditioning base. The building may further include defining at least one pattern, at least one etch of the pattern to create at least one layer, for at least one semiconducting material and forming at least one layer of metal to form at least one transistor circuit embodying the amplifier. The transistors preferably in use at the time of the invention include, but are not limited to, bipolar transistors, Field Effect Transistors (FETs), and amorphous transistors.

The flexure finger may include a micro-actuator assembly for mechanically coupling to an embodiment of the slider. The flexure finger may include a vertical control signal path providing the vertical control signal to the slider and the heating element in its vertical micro-actuator. The micro-actuator assembly may aid in lateral positioning, and may further aid in vertical positioning of the read-write head over the data of the rotating disk surface. The micro-actuator assembly may employ a piezoelectric effect and/or an electrostatic effect to aid in positioning the read-write head.

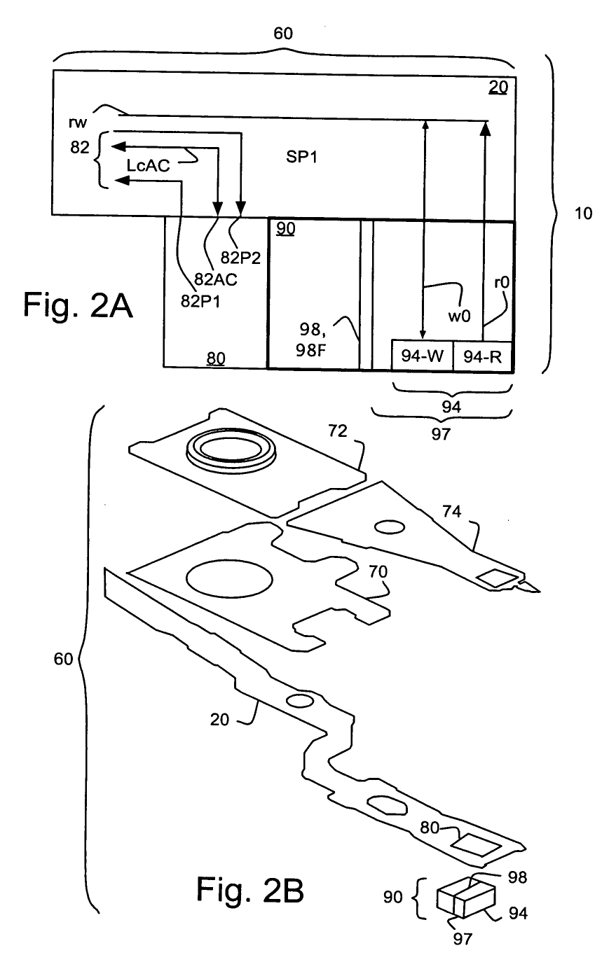

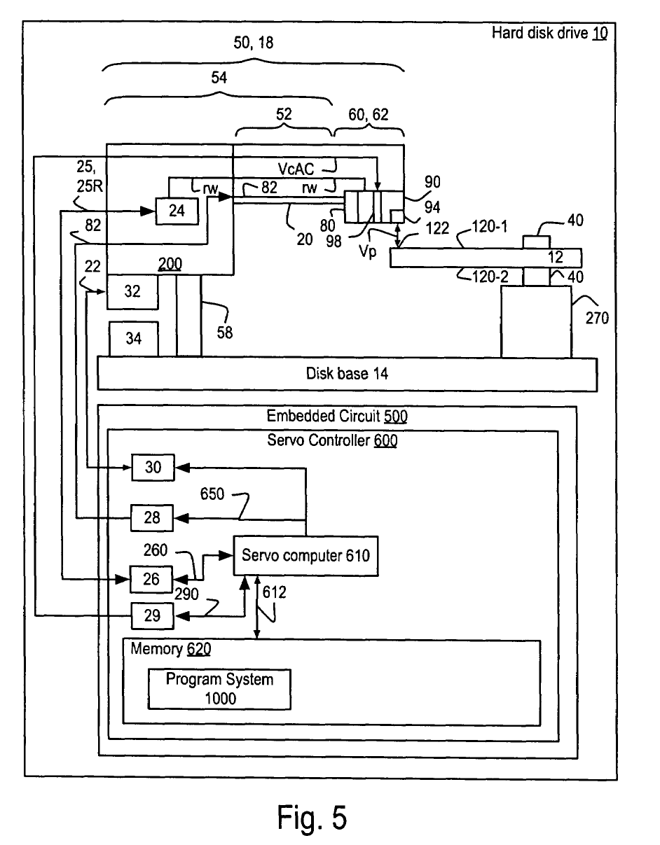

The flexure finger 20 for the slider 90 of FIGS. 2A, 5, 6, and 8B, which preferably contains a micro-actuator assembly 80 for mechanically coupling to the slider to aid in positioning the slider to access the data 122 on 120-1 rotating disk surface of the disk 12. The micro-actuator assembly may aid in laterally positioning LP the slider to the rotating disk surface as shown in FIG. 3A and/or aid in vertically positioning VP the slider as shown in FIGS. 1B, 1C and 5. When the slider 90 includes the vertical micro-actuator 98 with the heating element 98-H, the flexure finger 20 may further provide the vertical control signal VcAC and preferably the first lateral control signal 82P1 as the first slider power terminal SP1 to the vertical micro-actuator. The vertical micro-actuator, in particular, the heating element may preferably include Copper. The vertical micro-actuator, in particular, the heating element can be can be used to deform the deformation region when the temperature of the shape memory alloy film 98-F is below the first temperature.

The flexure finger 20 preferably includes the lateral control signal 82 and trace paths between the slider for the write differential signal pair w0. The lateral control signal preferably includes the first lateral control signal 82P1 and the second lateral control signal 82P2, as well as the AC lateral control signal 82AC. When the slider does not contain an amplifier 96, as shown in FIGS. 1B, 1C, 2A, 5 and 6, the flexure finger further preferably provides trace paths for the read differential signal pair r0.

The micro-actuator assembly 80 may employ a piezoelectric effect and/or an electrostatic effect to aid in positioning the slider 90. First, examples of micro-actuator assemblies employing the piezoelectric effect will be discussed followed by electrostatic effect examples. In several embodiments of the invention the micro-actuator assembly may preferably couple with the head gimbal assembly 60 through the flexure finger 20, as shown in FIGS. 2A, 2B, 5 and 8B. The micro-actuator assembly may further couple through the flexure finger to a load beam 74 to the head gimbal assembly and consequently to the head stack assembly 50.

Examples of micro-actuator assemblies employing the piezoelectric effect are shown in FIGS. 4B and 8A. FIG. 4B shows a side view of a head gimbal assembly with a micro-actuator assembly 80 including at least one piezoelectric element PZ1 for aiding in laterally positioning LP of the slider 90. In certain embodiments, the micro-actuator assembly may consist of one piezoelectric element. The micro-actuator assembly may include the first piezoelectric element and a second piezoelectric element PZ2, both of which may preferably aid in laterally positioning the slider. In certain embodiments, the micro-actuator assembly may be coupled with the slider with a third piezoelectric element PZ3 to aid in the vertically positioning the slider above the rotating disk surface 120-1.

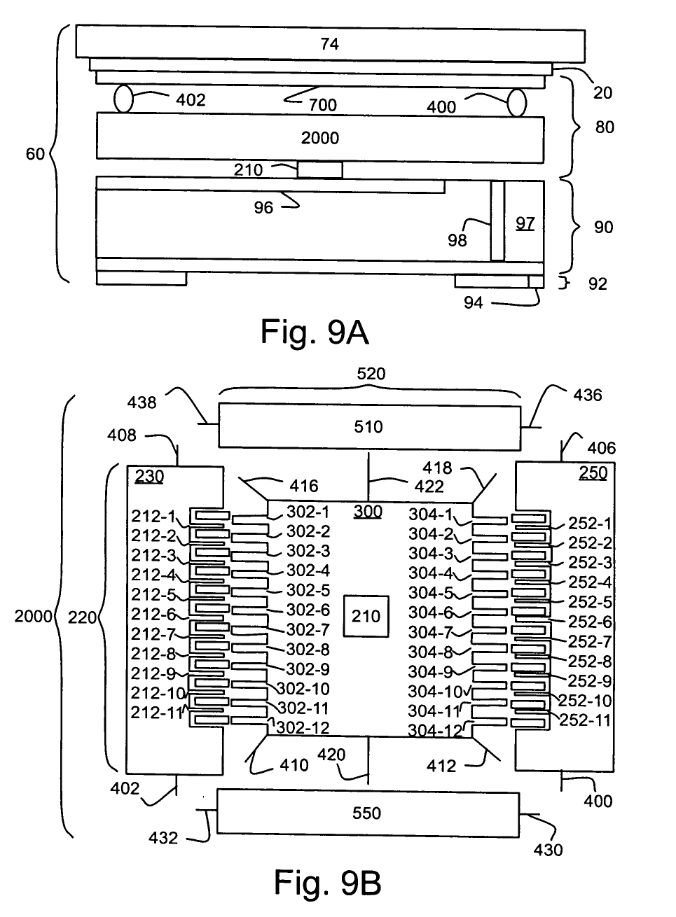

Examples of the invention using micro-actuator assemblies employing the electrostatic effect are shown in FIGS. 9A and 9B derived from the Figures of U.S. patent application Ser. No. 10/986,345, which is incorporated herein by reference. FIG. 9A shows a schematic side view of the micro-actuator assembly 80 coupling to the flexure finger 20 via a micro-actuator mounting plate 700. FIG. 9B shows the micro-actuator assembly using an electrostatic micro-actuator assembly 2000 including a first electrostatic micro-actuator 220 to aid the laterally positioning LP of the slider 90. The electrostatic micro-actuator assembly may further include a second electrostatic micro-actuator 520 to aid in the vertically positioning VP of the slider.

The first micro-actuator 220 includes the following. A first pivot spring pair 402 and 408 coupling to a first stator 230. A second pivot spring pair 400 and 406 coupling to a second stator 250. A first flexure spring pair 410 and 416, and a second flexure spring pair 412 and 418, coupling to a central movable section 300. A pitch spring pair 420-422 coupling to the central movable section 300. The central movable section 300 includes signal pair paths coupling to the write differential signal pair W0 and either the read differential signal pair r0 or the amplified read signal ar0 of the read-write head 94 of the slider 90.

The bonding block 210 may electrically couple the read-write head 90 to the amplified read signal ar0 and write differential signal pair W0, and mechanically couples the central movable section 300 to the slider 90 with read-write head 94 embedded on or near the air bearing surface 92 included in the slider.

The first micro-actuator 220 aids in laterally positioning LP the slider 90, which can be finely controlled to position the read-write head 94 over a small number of tracks 122 on the rotating disk surface 120-1. This lateral motion is a first mechanical degree of freedom, which results from the first stator 230 and the second stator 250 electrostatically interacting with the central movable section 300. The first micro-actuator 220 may act as a lateral comb drive or a transverse comb drive, as is discussed in detail in the incorporated United States patent application.

The electrostatic micro-actuator assembly 2000 may further include a second micro-actuator 520 including a third stator 510 and a fourth stator 550. Both the third and the fourth stator electrostatically interact with the central movable section 300. These interactions urge the slider 90 to move in a second mechanical degree of freedom, aiding in the vertically positioning VP to provide flying height control. The second micro-actuator may act as a vertical comb drive or a torsional drive, as is discussed in detail in the incorporated United States patent application. The second micro-actuator may also provide motion sensing, which may indicate collision with the rotating disk surface 120-1 being accessed.

The central movable section 300 not only positions the read-write head 10, but may act as the conduit for the write differential signal pair w0 and in certain embodiments, the first slider power signal SP1 and the second slider power signal SP2, as well as the read differential signal pair r0 or the amplified read signal ar0. The electrical stimulus of the first micro-actuator 220 is provided through some of its springs.

The central movable section 300 may preferably to be at ground potential, and so does not need wires. The read differential signal pair r0, the amplified read signal ar0, the write differential signal pair w0 and/or the slider power signals SP1 and SP2 traces may preferably be routed with flexible traces all the way to the load beam 74 as shown in FIG. 9A.

The flexure finger 20 may further provide a read trace path rtp for the amplified read signal ar0, as shown in FIG. 8B. The slider 90 may further include a first slider power terminal SP1 and a second slider power terminal SP2, both electrically coupled to the amplifier 96 to collectively provide power to generate the amplified read signal ar0. The flexure finger may further include a first power path SP1P electrically coupled to the first slider power terminal SP1 and/or a second power path SP2P electrically coupled to the second slider power terminal SP2, which are collectively used to provide electrical power to generate the amplified read signal.

The invention's head gimbal assembly includes the invention's flexure finger coupled to the slider, which further includes the micro-actuator assembly mechanically coupled to the slider and may further include the vertical control signal path electrically coupled to the vertical control signal of the slider. The invention's head stack assembly includes at least one of the head gimbal assemblies coupled to a head stack. The invention's hard disk drive includes a head stack assembly, which includes at least one of the head gimbal assemblies.

The head gimbal assembly 60 includes the flexure finger 20 coupled with the slider 90 and a micro-actuator assembly 80 mechanically coupling to the slider to aid in positioning the slider to access the data 122 on the rotating disk surface 120-1. The micro-actuator assembly may further include a first micro-actuator power terminal 82P1 and a second micro-actuator power terminal 82P2. The head gimbal assembly may further include the first micro-actuator power terminal electrically coupled to the first power path SP1P and/or the second micro-actuator power terminal electrically coupled to the second power path SP2P. Operating the head gimbal assembly may further preferably include operating the micro-actuator assembly to aid in positioning the slider to read access the data on the rotating disk surface, which includes providing electrical power to the micro-actuator assembly.

The head gimbal assembly 60 may further provide the vertical control signal VcAC to the heating element 98H of the vertical micro-actuator 98, as shown in FIGS. 5 and 8B. Operating the head gimbal assembly may further preferably include driving the vertical control signal. The first micro-actuator power terminal 82P1 may be tied to the first slider power terminal SP1, and both electrically coupled to the first power path SP1P.

The head gimbal assembly 60 may further include the amplifier 96 to generate the amplified read signal ar0 using the first slider power terminal SP1 and the second slider power terminal SP2. The flexure finger 20 may further contain a read trace path rtp electrically coupled to the amplified read signal ar0, as shown in FIG. 8B. The head gimbal assembly operates as follows when read accessing the data 122, preferably organized as the track 122, on the rotating disk surface 120-1. The slider 90 reports the amplified read signal ar0 as the result of the read access.

The flexure finger 20 may be coupled to the load beam 74 as shown in FIGS. 2B and 9A, which may further include the first power path SP1P electrically coupled to a metallic portion of the load beam. In certain embodiments, the metallic portion may be essentially all of the load beam.

In further detail, the head gimbal assembly 60 includes a base plate 72 coupled through a hinge 70 to a load beam 74. Often the flexure finger 20 is coupled to the load beam and the micro-actuator assembly 80 and slider 90 are coupled through the flexure finger to the head gimbal assembly. The load beam may preferably electrically couple to the slider to the first slider power terminal SP1, and may further preferably electrically couple to the micro-actuator assembly to form the first power path SP1P.

Manufacturing the invention's head gimbal assembly 60 includes coupling the flexure finger 20 to the invention's slider 90, which further includes mechanically coupling the micro-actuator assembly 80 to the slider. Coupling the flexure finger to the slider may further include electrically coupling the read trace path rtp with the amplified read signal ar0 as shown in FIG. 8B or alternatively, providing the read differential signal pair r0. Coupling the micro-actuator assembly to the slider may include electrically coupling the first micro-actuator power terminal 82P1 to the first slider power terminal SP1P and/or electrically coupling the second micro-actuator power terminal 82P2 to the second slider power terminal SP2P. The invention includes this manufacturing process and the head gimbal assembly as a product of the process. Manufacturing the invention's head gimbal assembly 60 may further include electrically coupling the flexure finger 20 to provide the vertical control signal VcAC to the slider 98.

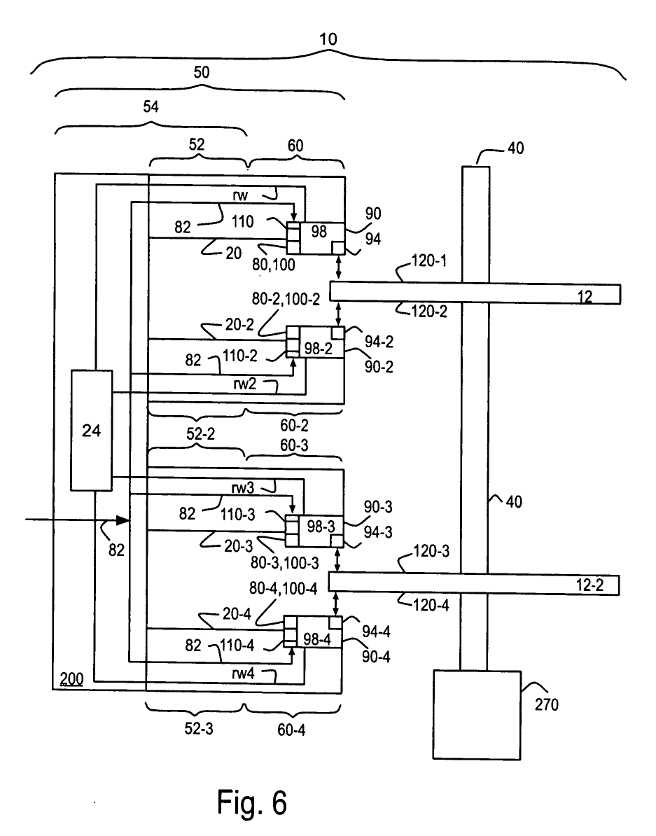

The invention also includes a head stack assembly 50 containing at least one head gimbal assembly 60 coupled to a head stack 54, as shown in FIGS. 5 and 6.

The head stack assembly 50 may include more than one head gimbal assembly 60 coupled to the head stack 54. By way of example, FIG. 6 shows the head stack assembly coupled with a second head gimbal assembly 60-2, a third head gimbal assembly 60-3 and a fourth head gimbal assembly 60-4. Further, the head stack is shown in FIG. 5 including the actuator arm 52 coupling to the head gimbal assembly. In FIG. 6, the head stack further includes a second actuator arm 52-2 and a third actuator arm 52-3, with the second actuator arm coupled to the second head gimbal assembly 60-2 and a third head gimbal assembly 60-3, and the third actuator arm coupled to the fourth head gimbal assembly 60-4. The second head gimbal assembly includes the second slider 90-2, which contains the second read-write head 94-2. The third head gimbal assembly includes the third slider 90-3, which contains the third read-write head 94-3. And the fourth head gimbal assembly includes a fourth slider 90-4, which contains the fourth read-write head 94-4.

The head stack assembly 50 operates as follows: for each of the sliders 90 included in each of the head gimbal assemblies 60 of the head stack, when the temperature of the shape memory alloy film of the slider is below the first temperature, the film configures in a first solid phase to the deformation region 97 to create the vertical position VP of that read-write head above its rotating disk surface. Whenever the temperature of the film of the shape memory alloy is above the first temperature, the film configures in a second solid phase to the deformation region increasing the vertical position of the read-write head above the rotating disk surface.

In certain embodiments where the slider 90 includes the amplifier 96, the slider reports the amplified read signal ar0 as the result of the read access to the track 122 on the rotating disk surface 120-1. The flexure finger provides the read trace path rtp for the amplified read signal, as shown in FIG. 4B. The head stack assembly 50 may include a main flex circuit 200 coupled with the flexure finger 20, which may further include a preamplifier 24 electrically coupled to the read trace path rtp in the read-write signal bundle rw to create the read signal 25-R based upon the amplified read signal as a result of the read access.

Manufacturing the invention's head stack assembly 50 includes coupling at least one of the invention's head gimbal assembly 60 to the head stack 50 to at least partly create the head stack assembly. The process may further include coupling more than one head gimbal assemblies to the head stack. Manufacturing may further, preferably include coupling the main flex circuit 200 to the flexure finger 20, which further includes electrically coupled the preamplifier 24 to the read trace path rtp to provide the read signal 25-R as a result of the read access of the data 122 on the rotating disk surface 120-1. The invention includes the manufacturing process for the head stack assembly and the head stack assembly as a product of the manufacturing process. Coupling the head gimbal assembly 60 to the head stack 50 may further, preferably include swaging the base plate 72 to the actuator arm 52.

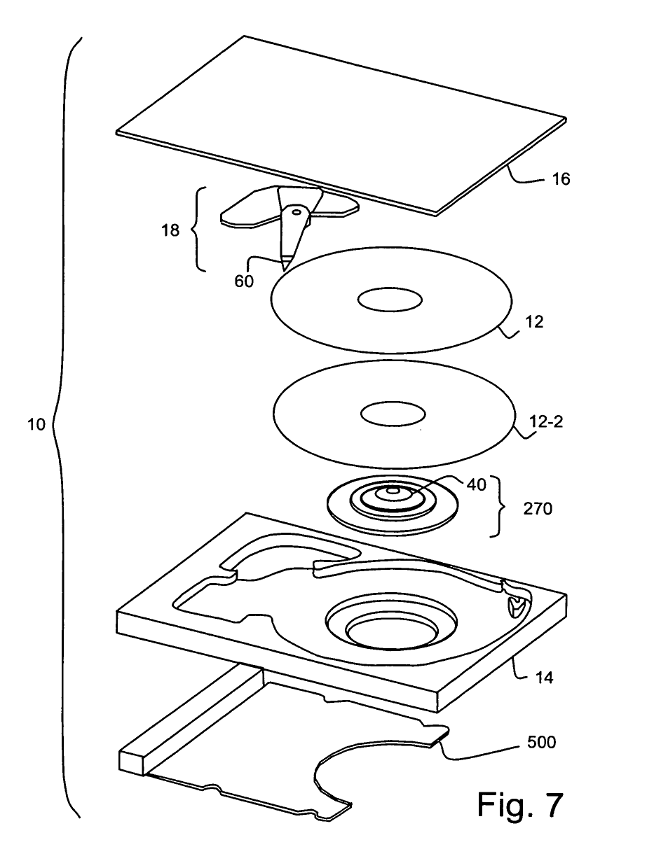

The invention's hard disk drive 10, shown in FIGS. 2A, 4A, 5, 6, and 7, includes the invention's head stack assembly 50 pivotably mounted through the actuator pivot 58 on a disk base 14 and arranged for the slider 90 of the head gimbal assembly 60 to be laterally positioned LP near the data 122 for the read-write head 94 to access the data on the rotating disk surface 120-1. The disk 12 is rotatably coupled to the spindle motor 270 by the spindle shaft 40. The head stack assembly is electrically coupled to an embedded circuit 500. The data may be organized on the rotating disk surface either as a radial succession of concentric circular tracks or a radial succession of joined spiral tracks.

The hard disk drive 10 may include the servo controller 600, and possibly the embedded circuit 500, coupled to the voice coil motor 18, to provide the micro-actuator stimulus signal 650 driving the micro-actuator assembly 80, and the read signal 25-R based upon the amplified read signal ar0 contained in the read-write signal bundle rw from the read-write head 94 to generate the Position Error Signal 260.

The embedded circuit 500 may preferably include the servo controller 600, as shown in FIG. 5, which may further include a servo computer 610 accessibly coupled 612 to a memory 620. A program system 1000 may direct the servo computer in implementing the method operating the hard disk drive 10. The program system preferably includes at least one program step residing in the memory. The embedded circuit may preferably be implemented with a printed circuit technology. The lateral control signal 82 may preferably be generated by a micro-actuator driver 28. The lateral control signal preferably includes the first lateral control signal 82P1 and the second lateral control signal 82P2, as well as the AC lateral control signal 82AC.

The voice coil driver 30 preferably stimulates the voice coil motor 18 through the voice coil 32 to provide coarse position of the slider 90, in particular, the read head 94-R near the track 122 on the rotating disk surface 120-1.

The embedded circuit 500 may further process the read signal 25-R during the read access to the data 122 on the rotating disk surface 120-1. The slider 90 reports the amplified read signal ar0 as the result of a read access of the data 122 on the rotating disk surface 120-1. The flexure finger 20 provides the read trace path rtp for the amplified read signal, as shown in FIG. 4B. The main flex circuit 200 receives the amplified read signal from the read trace path to create the read signal 25-R. The embedded circuit receives the read signal to read the data on the rotating disk surface.

A computer as used herein may include at least one instruction processor and at least one data processor, where each of the data processors is directed by at least one of the instruction processors.

Manufacturing the hard disk drive 10 may include pivotably mounting the head stack assembly 50 by an actuator pivot 58 to the disk base 14 and arranging the head stack assembly, the disk 12, and the spindle motor 270 for the slider 90 of the head gimbal assembly 60 to access the data 122 on the rotating disk surface 120-1 of the disk 12 rotatably coupled to the spindle motor, to at least partly create the hard disk drive. The invention includes this manufacturing process and the hard disk drive as a product of that process.

Manufacturing may further include electrically coupling the invention's head stack assembly 50 to the embedded circuit 500 to provide the read signal 25-R as the result of the read access of the data 122 on the rotating disk surface 120-1. Making the hard disk drive 10 may further include coupling the servo controller 600 and/or the embedded circuit 500 to the voice coil motor 18 and providing the micro-actuator stimulus signal 650 to drive the micro-actuator assembly 80. Making the hard disk drive may further include electrically coupling the vertical control driver of the embedded circuit to the vertical control signal VcAC of the slider 90 through the head stack assembly 50, in particular through the flexure finger 20.

Making the servo controller 600 and/or the embedded circuit 500 may include programming the memory 620 with the program system 1000 to create the servo controller and/or the embedded circuit, preferably programming a non-volatile memory component of the memory. Making the embedded circuit 500, and in some embodiments, the servo controller 600, may include installing the servo computer 610 and the memory 620 into the servo controller and programming the memory with the program system 1000 to create the servo controller and/or the embedded circuit.

Looking at some of the details of FIG. 6, the hard disk drive 10 includes a disk 12 and a second disk 12-2. The disk includes the rotating disk surface 120-1 and a second rotating disk surface 120-2. The second disk includes a third rotating disk surface 120-3 and a fourth rotating disk surface 120-4. The voice coil motor 18 includes an head stack assembly 50 pivoting through an actuator pivot 58 mounted on the disk base 14, in response to the voice coil 32 mounted on the head stack 54 interacting with the fixed magnet 34 mounted on the disk base. The actuator assembly includes the head stack with at least one actuator arm 52 coupling to a slider 90 containing the read-write head 94. The slider is coupled to the micro-actuator assembly 80.

The read-write head 94 interfaces through a preamplifier 24 on a main flex circuit 200 using a read-write signal bundle rw typically provided by the flexure finger 20, to a channel interface 26 often located within the servo controller 600. The channel interface often provides the Position Error Signal 260 (PES) within the servo controller. It may be preferred that the micro-actuator stimulus signal 650 be shared when the hard disk drive includes more than one micro-actuator assembly. It may be further preferred that the lateral control signal 82 be shared. Typically, each read-write head interfaces with the preamplifier using separate read and write signals, typically provided by a separate flexure finger. For example, the second read-write head 94-2 interfaces with the preamplifier via a second flexure finger 20-2, the third read-write head 94-3 via the a third flexure finger 20-3, and the fourth read-write head 94-4 via a fourth flexure finger 20-4.

During normal disk access operations, the hard disk drive 10 operates as follows when accessing the data 122 on the rotating disk surface 120-1. The spindle motor 270 is directed by the embedded circuit 500, often the servo-controller 600, to rotate the disk 12, creating the rotating disk surface for access by the read-write head 94. The embedded circuit, in particular, the servo controller drives the voice coil driver 30 to create the voice coil control signal 22, which stimulates the voice coil 32 with an alternating current electrical signal, inducing a time-varying electromagnetic field, which interacts with the fixed magnet 34 to move the voice coil parallel the disk base 14 through the actuator pivot 58, which alters the lateral position LP of the read-write head of the slider 90 in the head gimbal assembly 60 coupled to the actuator arm 52, which is rigidly coupled to the head stack 54 pivoting about the actuator pivot. Typically, the hard disk drive first enters track seek mode, to coarsely position the read-write head near the data, which as stated above, is typically organized as a track. Once the read-write head is close to the track, track following mode is entered. Often this entails additional positioning control provided by the micro-actuator assembly 80 stimulated by the lateral control signal 82, which is driven by the micro-actuator driver 28. Reading the track may also include generating a Position Error Signal 260, which is used by the servo controller as positioning feedback during track following mode.

The hard disk drive 10 may operate by driving the vertical control signal VcAC to stimulate the vertical micro-actuator 98 to increase the vertical position VP of the slider 90 by providing a potential difference to the first slider terminal SP1, stimulating the heating element 98H to increase the temperature of the shape memory alloy film 98F, as shown in FIG. 1B. This operation may be performed when seeking a track 122 of data on the rotating disk surface 120-1, and/or when following the track on the rotating disk surface. As stated before, whenever the temperature of the film is below a first temperature, the film configures in a first solid phase to the deformation region 97 to create the vertical position of the read-write head above the rotating disk surface. Whenever the temperature of the film is above the first temperature, the film configures in a second solid phase to the deformation region increasing the vertical position of the read-write head above the rotating disk surface. The servo controller 600 may include means for driving the vertical control signal, which may be at least partly implemented by the vertical control driver 29 creating the vertical control signal to be provided to the vertical micro-actuator. The vertical control driver is typically an analog circuit with a vertical position digital input 290 driven by the servo computer 610 to create the vertical control signal.

Track following and track seeking may be implemented as means for track seeking and means for track following, one or both of which may be implemented at least in part as program steps in the program system 1000 residing in the memory 620 accessibly coupled 612 to the servo computer 610 shown in FIG. 5. Alternatively, the means for track seeking and/or the means for track following may be implemented as at least one finite state machine.

The preceding embodiments provide examples of the invention and are not meant to constrain the scope of the following claims.

What is claimed is:

1. A slider, comprising:
a vertical micro-actuator including a film of a shape memory alloy perpendicular to an air bearing surface and coupled to a deformation region including a read-write head for accessing data on a rotating disk surface in a hard disk drive;
wherein whenever the temperature of said film of said shape memory alloy is below a first temperature, said film configures in a first solid phase to said deformation region to create the vertical position of said read-write head above said rotating disk surface; and
wherein whenever said temperature of said film of said shape memory alloy is above said first temperature, said film configures in a second solid phase to said deformation region increasing said vertical position of said read-write head above said rotating disk surface.

2. The slider of claim 1, wherein said read-write head, includes:
a read head using a member of the group, consisting of: a spin valve to read said data on said rotating disk surface, and a tunneling valve to read said data on said rotating disk surface.

3. The slider of claim 2, wherein said slider, further comprises:
said read-write head providing a read differential signal pair to an amplifier to generate an amplified read signal reported by said slider as a result of read access of said data on said rotating disk surface.

4. The slider of claim 3, wherein said amplifier is opposite said air bearing surface.

5. The slider of claim 3, wherein said amplifier is separate from said deformation region.

6. The slider of claim 5, wherein said amplifier is separate from said vertical micro-actuator.

7. The slider of claim 1, wherein said vertical micro-actuator, further includes at least one member of the group consisting of:
a heating element coupled to said film formed of said shape memory alloy stimulated by a vertical control signal and a first slider power terminal provided to said heating element to create a potential difference, stimulating said heating element to increase said temperature of said film of said shape memory alloy; and
a second heating element embedded in said deformation region stimulated by a second vertical control signal and said first slider power terminal provided to said second heating element to create a second potential difference, stimulating said second heating element to increase said temperature of said deformation region to reduce said vertical position.

8. A flexure finger for said slider of claim 7, comprising:
a micro-actuator assembly for coupling to said slider to aid in positioning said slider to access said data on said rotating disk surface; and further comprising at least one member of the group consisting of:
a vertical control signal path providing said vertical control signal to said slider; and
a second vertical control signal path providing said second vertical control signal to said slider.

9. A head gimbal assembly, comprising: said flexure finger of claim 8 coupled with said slider, further comprising:
said micro-actuator mechanically coupled to said slider to aid in positioning said slider to access said data on said rotating disk surface; and
wherein said head gimbal assembly further comprises at least one member of the group consisting of:
said vertical control signal path electrically coupled to said vertical control signal of said slider;
said second control signal path electrically coupled to said second vertical control signal of said slider.

10. The head gimbal assembly of claim 9, further comprising:
a load beam electrically coupled through a via to said flexure finger to said first slider power terminal in said slider.

11. The head gimbal assembly of claim 9, wherein said micro-actuator assembly includes a first micro-actuator power terminal electrically coupled to said first slider power terminal.

12. A head stack assembly, comprising: at least one of the head gimbal assemblies of claim 9 coupled to a head stack.

13. The hard disk drive, comprising: said head stack assembly of claim 12 pivotably mounted on a disk base and arranged for said slider of said head gimbal assembly to access said data on said rotating disk surface of said disk rotatably coupled to a spindle motor.

14. A method of manufacturing said hard disk drive of claim 13, comprising the steps:
pivotably mounting said head stack assembly by an actuator pivot to said disk base;
arranging said head stack assembly, said disk, and said spindle motor for said slider of said head gimbal assembly to access said data on said rotating disk surface of said disk rotatably coupled to said spindle motor to create said hard disk drive.

15. The hard disk drive as a product of the process of claim 14.

16. A method of operating said hard disk drive of claim 15, comprising the steps:
driving said vertical control signal to stimulate said vertical micro-actuator to increase said vertical position.

17. The method of claim 16, further comprising the steps:
seeking a track of said data on said rotating dusk surface, further comprising the step:
driving said vertical control signal to stimulate said vertical micro-actuator to increase said vertical position; and
following said track of said data on said rotating disk surface, further comprising the steps:
driving said vertical control signal to stimulate said vertical micro-actuator to increase said vertical position.

18. A method of manufacturing said head stack assembly of claim 12, comprising the step:
coupling said at least one of said head gimbal assembly to said head stack to create said head stack assembly.

19. The head stack assembly as a product of the process of claim 18.

20. A method of manufacturing said head gimbal assembly of claim 9, comprising the step:
coupling said flexure finger with said slider to create said head gimbal assembly, further comprising the steps:
mechanically coupling said micro-actuator assembly to said slider; and
electrically coupling said first slider power terminal through said flexure finger.

21. The head gimbal assembly as a product of the process of claim 20.

22. A method of manufacturing said flexure finger of claim 7, comprising the steps:
forming said vertical control signal path and said micro-actuator assembly to create said flexure finger.

23. The flexure finger as a product of the process of claim 22.

24. A flexure finger for said slider of claim 1, comprising:
a micro-actuator assembly for coupling to said slider to aid in positioning said slider to access said data on said rotating disk surface.

25. The flexure finger of claim 24, wherein said micro-actuator assembly aids in laterally positioning said read-write head to access said data on said rotating disk surface.

26. The flexure finger of claim 25, wherein said micro-actuator assembly aids in vertically positioning said read-write head to access said data on said rotating disk surface.

27. The flexure finger of claim 24, wherein said micro-actuator assembly employs at least one member of the group, consisting of: a piezoelectric effect and an electrostatic effect, to position said slider to access said data on said rotating disk surface.

28. A head gimbal assembly, comprising: said flexure finger of claim 24 coupled with said slider, further comprising:
said micro-actuator mechanically coupled to said slider to aid in positioning said slider to access said data on said rotating disk surface.

29. A head stack assembly, comprising: at least one of the head gimbal assemblies of claim 28 coupled to a head stack.

30. The head stack assembly of claim 29, further comprising: at least two of said head gimbal assemblies coupled to said head stack.

31. The hard disk drive, comprising: said head stack assembly of claim 29 pivotably mounted on a disk base and arranged for said slider of said head gimbal assembly to access said data on said rotating disk surface of said disk rotatably coupled to a spindle motor.

32. A method of manufacturing said hard disk drive of claim 31, comprising the steps:
pivotably mounting said head stack assembly by an actuator pivot to said disk base;
arranging said head stack assembly, said disk, and said spindle motor for said slider of said head gimbal assembly to access said data on said rotating disk surface of said disk rotatably coupled to said spindle motor to create said hard disk drive.

33. The hard disk drive as a product of the process of claim 32.

34. A method of manufacturing said head stack assembly of claim 29, comprising the step:
coupling said at least one of said head gimbal assembly to said head stack to create said head stack assembly.

35. The head stack assembly as a product of the process of claim 34.

36. A method of manufacturing said head gimbal assembly of claim 28, comprising the step:
coupling said flexure finger with said slider to create said head gimbal assembly, further comprising the step:
mechanically coupling said micro-actuator assembly to said slider.

37. The head gimbal assembly as a product of the process of claim 36.

38. A method of manufacturing said flexure finger of claim 24, comprising the steps:
forming said micro-actuator assembly to create said flexure finger.

39. The flexure finger as a product of the process of claim 38.

40. A method of manufacturing said slider of claim 1, comprising the steps:
forming said vertical micro-actuator to include said film of said shape memory alloy;
coupling said vertical micro-actuator to said deformation region including said read-write head; and
forming said air bearing surface perpendicular to said film to create said slider.

41. The method of claim 40,
wherein the step forming said vertical micro-actuator, further comprises at least one member of the group consisting of the steps:
sputtering to create said film of said shape memory alloy; and
separately fabricating said film of said shape memory alloy;
wherein the step coupling said vertical micro-actuator, further comprises at least one member of the group consisting of the steps:
depositing said vertical actuator on said deformation region; and
bonding said vertical micro-actuator to said deformation region.

42. The method of claim 40, further comprising the step:
forming a heating element coupled with said film of said shape memory alloy to create said vertical micro-actuator.

43. The method of claim 40, wherein said shape memory alloy includes at least one member of a titanium nickel shape memory alloy group consisting of:
a Titanium Nickel (TiNi) alloy;
a Titanium Nickel Iron (Ti—Ni—Fe) alloy;
a Titanium Nickel Copper (Ti—Ni—Cu) alloy;
a Titanium Nickel Lead (Ti—Ni—Pb) alloy; and
a Titanium Nickel Hafnium (Ti—Ni—Hf) alloy.

44. The slider as a product of the process of claim 40.
